(19) United States
(12) Patent Application Publication
(10) Pub. No.: US 2026/0357787 A1
(43) Pub. Date: Nov. 12, 2026

(54) Wind Power Generation Device and System

(71) Applicant: Alan wing shum, Brooklyn, NY (US)

(72) Inventor: Alan wing shum, Brooklyn, NY (US)

(21) Appl. No.: 19/666,671

(22) Filed: May 4, 2026

Related U.S. Application Data
(60) Provisional application No. 63/802,797, filed on May 9, 2025.

(51) Int. Cl. F03D 15/10; F01D 15/10; F01D 15/12

(52) U.S. Cl. CPC F03D 15/10; F01D 15/10; F01D 15/12; F05B 2220/702; F05D 2220/64

(57) ABSTRACT

A wind power generation device and system are provided. The device includes a fan system, a compressed gas system, and a power system. The fan system includes a fan, a central shaft, and a gear assembly having a hexagonal steel plate, a plurality of gears, connecting rods, and crossbars. Wind-driven rotation of the fan is transmitted through the gear assembly to drive air pumps that generate compressed air. The compressed gas system includes air pumps, an inlet, air cylinders, and an outlet, wherein compressed air is stored and regulated using pressure-regulating valves and variable-volume chambers. The power system includes a steam engine driven solely by compressed air to generate electricity without combustion. A system configuration includes a plurality of fan systems sharing a common compressed gas system with flow control mechanisms and pressure-regulating elements to provide stabilized compressed air output independent of wind fluctuations.

### FIELD OF THE DISCLOSURE

The present invention relates to wind power generation technology, and more particularly, to a wind power generation device and system that converts wind force into compressed air for driving a steam engine to generate electrical power.

### BACKGROUND OF THE DISCLOSURE

Conventional wind power generation systems typically use wind turbines with blades connected directly to electrical generators. As wind speed fluctuates, these conventional systems experience intermittent power output, making it difficult to provide stable, continuous electricity. Energy storage solutions such as battery systems have been developed to address this intermittency, but batteries have limited lifespans, high costs, and environmental concerns related to manufacturing and disposal.

Conventional wind turbine systems also face mechanical limitations. Direct-drive generators experience high stress during wind gusts, leading to wear and maintenance requirements. Gear-based transmission systems in conventional wind turbines are complex and require frequent lubrication and maintenance.

Additionally, conventional renewable energy systems often depend on grid infrastructure for load balancing. During periods of low wind, conventional wind turbine power generation facilities cannot guarantee power supply without backup systems relying on fossil fuel generators, undermining environmental benefits.

There exists a need for a wind power generation technology that can provide stable, continuous power output independent of instantaneous wind variations, utilize simple mechanical components with reduced maintenance requirements, and eliminate dependence on battery storage or fossil fuel backup systems.

### BRIEF SUMMARY OF THE DISCLOSURE

In view of the aforementioned drawbacks of the prior art, it is an objective of the disclosure to provide a wind power generation device and system that addresses the limitations of conventional wind power technology by converting wind force into compressed air, storing the compressed air in cylinders, and using the compressed air to drive a steam engine for continuous power generation.

To achieve the above and other objectives, the disclosure provides a wind power generation device, comprising: at least one fan system comprising a fan, a central shaft, and a gear assembly, wherein gear assembly comprises a hexagonal steel plate, a largest gear, at least one medium gear, at least one small gear, at least one connecting rod, and at least one crossbar, the fan being connected to the central shaft, the largest gear meshing with the at least one medium gear, the at least one medium gear each being supported by a ball bearing shaft and meshing with the at least one small gear, the at least one small gear having an inner ring connected to one end of the at least one connecting rod, the at least one crossbar being fixed on a side edge of the hexagonal steel plate and having one end meshing with the at least one connecting rod, wherein the largest gear, the at least one medium gear, the at least one small gear being mounted on the hexagonal steel plate, and the at least one connecting rod being operatively connected to the at least one small gear and disposed around the gear assembly, wherein the fan is configured to rotate in response to wind force, the rotation of the fan drives the central shaft and the largest gear to rotate, the largest gear drives the at least one medium gear and the at least one small gear to rotate, and the at least one small gear drives the at least one connecting rod to convert the wind force into compressed air; a compressed gas system comprising at least one air pump, at least one inlet, at least one air cylinder, and at least one outlet, wherein the at least one air pump is mechanically connected to the gear assembly and fluidly connected to the at least one inlet, the at least one inlet is fluidly connected to the at least one air cylinder, the at least one air cylinder is fluidly connected to the at least one outlet, the at least one small gear drives the at least one connecting rod to actuate the at least one air pump to perform a pumping action that compresses air to generate compressed air delivered through the at least one inlet to the at least one air cylinder and discharged through the at least one outlet; and a power system comprising a steam engine fluidly connected to the at least one outlet and configured to be driven by the compressed air.

To achieve the above and other objectives, the disclosure further provides a wind power generation system, comprising: a plurality of fan systems, each fan system comprising a fan, a central shaft, and a gear assembly configured to drive at least one air pump; a compressed gas system shared among the plurality of fan systems, the compressed gas system comprising: a plurality of air pumps respectively driven by the plurality of fan systems, at least one inlet manifold fluidly connected to the plurality of air pumps, a plurality of air cylinders fluidly connected to the inlet manifold, and at least one outlet fluidly connected to the plurality of air cylinders; and a power system comprising a steam engine fluidly connected to the at least one outlet; wherein the compressed gas system further comprises at least one flow control mechanism comprising at least one pressure-regulating valve configured to: regulate compressed air input from the plurality of air pumps into the plurality of air cylinders based on pressure conditions within the compressed gas system, and selectively distribute compressed air from the plurality of air cylinders to the steam engine to provide a compressed air output having reduced pressure fluctuations and being independent of instantaneous wind force variations across the plurality of fan systems.

The wind power generation device and system of the disclosure offer several advantages:
(1) Continuous 24-hour power generation: By storing compressed air in cylinders, the system provides stable power output regardless of wind speed fluctuations, enabling uninterrupted electricity generation.
(2) Environmental benefits: The system uses wind force as the primary energy source without combustion, eliminating carbon emissions while reducing reliance on conventional fossil fuels.
(3) Mechanical simplicity: The gear assembly and air pump configuration provide reliable mechanical energy conversion with reduced maintenance compared to conventional wind turbine generators.
(4) Scalability: The system can be configured with different numbers of fan systems and air cylinders to suit applications ranging from residential rooftops to large-scale power stations.
(5) Wind speed balancing: A plurality of air cylinders working together dampen pressure fluctuations caused by varying wind speeds, ensuring smooth power delivery to the steam engine.

The details of one or more implementations of the subject matters described in this disclosure are set forth in the accompanying drawings and the description below. Other features, aspects, and advantages of the subject matters will become apparent from the description, the drawings, and the claims.

### BRIEF DESCRIPTION OF THE DRAWINGS

It should be noted that the drawing figures may be in simplified form and might not be of a precise scale. In reference to the disclosure herein, for purposes of convenience and clarity only, directional terms such as “windward,” “outward,” and “toward” are used with respect to the accompanying drawings. Such directional terms should not be construed to limit the scope of the embodiment in any manner.

FIG. 1 is a schematic view of the overall system architecture showing integration of multiple fan systems, compressed gas storage, and final power output according to the disclosure.

FIG. 2 is a top view of a gear assembly, focusing on a hexagonal steel plate and the gear-train relationship.

FIG. 3 is a schematic view of a compressed gas system, detailing the flow regulation from pumps to cylinders.

FIG. 4 is a schematic view of the kinematic layout of hexagonal pumping configuration, showing how 24 pumps are actuated.

FIG. 5 is a schematic view of a wind power generation device of the disclosure.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

This description is intentionally extensive and descriptive so as to satisfy the written description and enablement requirements of patent law, while preserving strategic flexibility and avoiding unnecessary limitations. The embodiments described herein are illustrative in nature and are not intended to limit the scope of the disclosure. Any feature, structure, orientation, material, or operational state described herein may be omitted, combined, modified, or substituted unless expressly required by the claims.

As used herein, the singular forms “a” and “an” include plural referents unless the context clearly indicates otherwise.

Unless defined otherwise, all technical and position terms used herein have the same meaning as commonly understood by one of ordinary skill in the art to which the invention pertains. In describing and claiming the present invention, the following terminology will be used in accordance with the definitions set out below.

### Overall System Architecture

The disclosure provides a wind power generation device 20. The wind power generation device 20, in its basic form, comprises a fan system 300, a compressed gas system 400, and a power system 500. In scaled embodiments, the disclosure further provides a wind power generation system 10 comprising a plurality of fan systems 300 operatively coupled to a shared compressed gas system 400 and a common power system 500, as described in detail below.

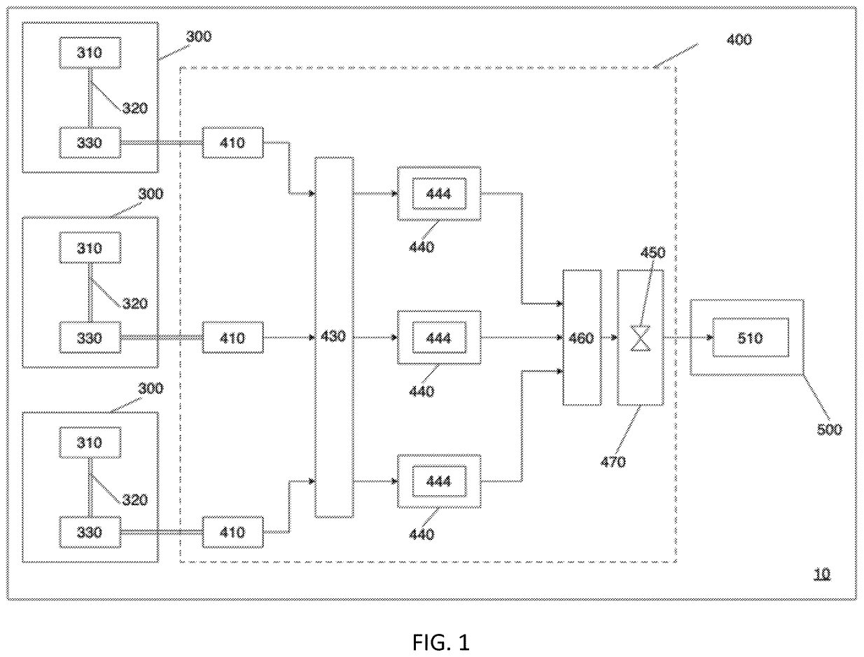

Referring to FIG. 1, the wind power generation system 10 of the disclosure comprises three main subsystems: the plurality of fan systems 300 for rotating in response to wind force and converting it into mechanical rotation, the compressed gas system 400 for generating and storing compressed air, and the power system 500 for converting compressed air into electrical power.

### Fan System Structure

Referring to FIGS. 1, 2, 4, and 5, the fan system 300 comprises a fan 310, a central shaft 320, and a gear assembly 330. The gear assembly 330 is operatively coupled to at least one air pump 410 through at least one connecting rod 348 and at least one crossbar 350 such that rotation of the fan 310 is mechanically converted into actuation of the at least one air pump 410. The fan 310 is disposed at the front of the system to rotate in response to incoming wind force. The fan 310 comprises a plurality of blades 312 arranged radially around a central hub 318. In a preferred embodiment, each blade 312 has a jet nozzle disposed on its windward surface 314. The jet nozzle is configured to direct airflow along the windward surface 314 to accelerate the rotational speed of the fan 310 by creating additional aerodynamic thrust.

The fan 310 is connected to the central shaft 320, which transfers rotational motion from the fan 310 to the gear assembly 330. The central shaft 320 is supported by bearings (not shown) to enable smooth rotation.

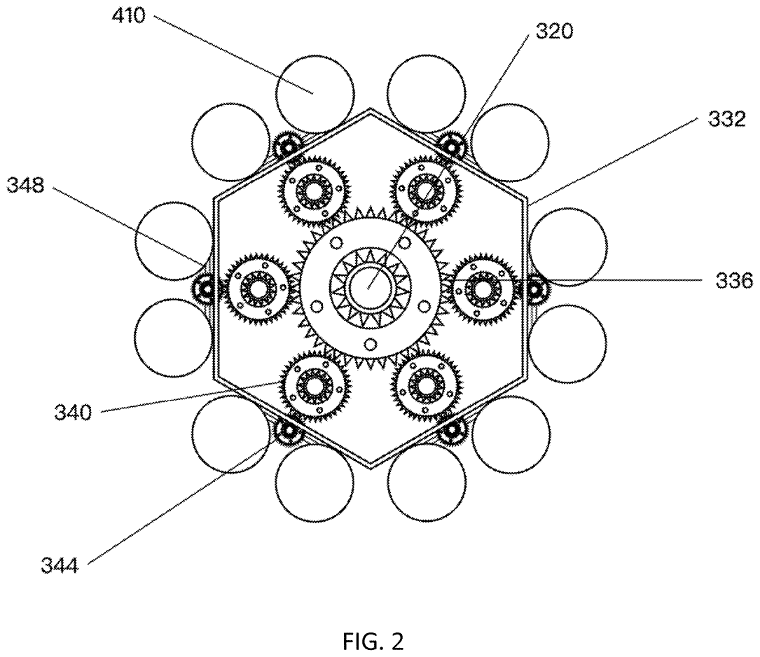

The gear assembly 330 comprises a hexagonal steel plate 332, a largest gear 336, at least one medium gear 340, at least one small gear 344, at least one connecting rod 348, and at least one crossbar 350. The hexagonal steel plate 332 serves as a mounting platform for all gear components and provides structural rigidity to the gear assembly 330. As shown in FIG. 2, the hexagonal steel plate 332 has six side edges 334 defining a geometric boundary of the gear assembly 330, such that the largest gear 336, the at least one medium gear 340, and the at least one small gear 344 are mounted within the boundary of the hexagonal steel plate 332.

In a preferred embodiment, the at least one small gear 344 is positioned adjacent to a respective side edge 334 of the hexagonal steel plate 332 such that the at least one small gear 344 is circumferentially distributed around a perimeter region 710 of the hexagonal steel plate 332.

The largest gear 336 is mounted at the center of the hexagonal steel plate 332 and is directly connected to the central shaft 320. Each of the largest gear 336, the at least one medium gear 340, and the at least one small gear 344 is mounted to the hexagonal steel plate 332 by a respective shaft, pivot, or mounting structure configured to maintain positional stability during rotation. The at least one connecting rod 348 is operatively connected to the at least one small gear 344 and disposed around the gear assembly 330. As the fan 310 rotates, the central shaft 320 drives the largest gear 336 to rotate at the same speed as the fan 310.

The at least one medium gear 340 is mounted on the hexagonal steel plate 332 and meshes with the largest gear 336. Each medium gear 340 is supported by a ball bearing shaft 342 to reduce friction and enable smooth rotation. The ball bearing shaft 342 is disposed through the center of each medium gear 340 and is mounted to the hexagonal steel plate 332. When the largest gear 336 rotates, it drives each medium gear 340 to rotate at a speed determined by the gear ratio between the largest gear 336 and the medium gear 340.

The at least one small gear 344 is mounted on the hexagonal steel plate 332 and meshes with a corresponding one of the at least one medium gear 340. Each small gear 344 has an inner ring 346 that is connected to one end of the at least one connecting rod 348. When the medium gear 340 rotates, it drives the small gear 344 to rotate at a higher speed determined by the gear ratio between the medium gear 340 and the small gear 344.

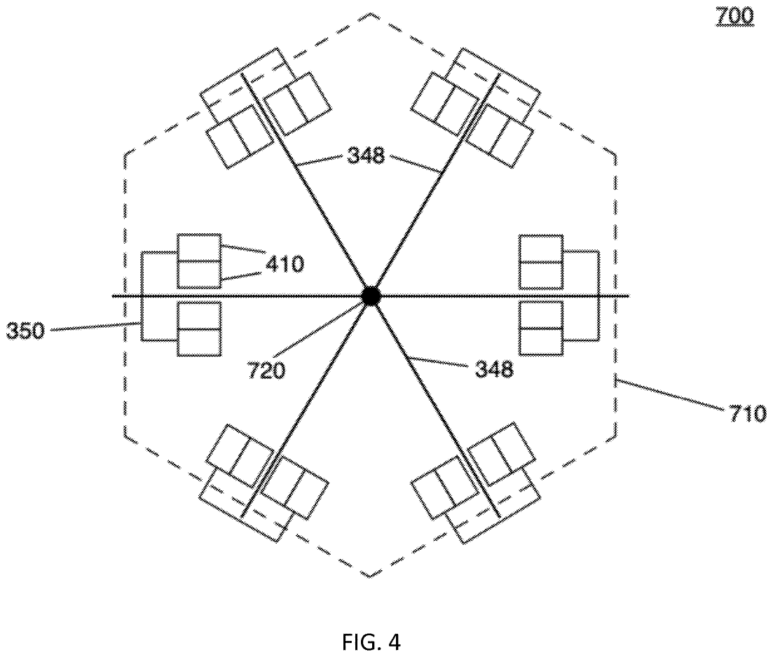

The at least one connecting rod 348 is disposed radially around the gear assembly 330. One end of each connecting rod 348 is connected to the inner ring 346 of a corresponding one of the at least one small gear 344, while the connecting rod 348 extends outward from the gear assembly 330. In the detailed configuration shown in FIG. 4, each connecting rod 348 encircles a side edge of its corresponding small gear 344, meaning that as viewed from above the hexagonal steel plate 332, the connecting rods 348 are arranged radially and their collective arrangement forms a larger hexagonal perimeter that defines the outer edge of the gear assembly 330. This encircling arrangement ensures that the connecting rods 348 are positioned symmetrically around the central axis 720 of the gear assembly 330, providing balanced force transmission during rotation.

As illustrated in FIGS. 2 and 4, each connecting rod 348 extends radially outward from the hexagonal steel plate 332 toward the perimeter region 710 surrounding the gear assembly 330. As the small gear 344 rotates, it drives the connecting rod 348 in a reciprocating motion that will be used to drive the at least one air pump 410.

The at least one crossbar 350 is fixed on a side edge 334 of the hexagonal steel plate 332. Each crossbar 350 has one end meshing with a connecting rod 348. The crossbar 350 extends from the connecting rod 348 toward the at least one air pump 410 in the compressed gas system 400. In a preferred embodiment, each connecting rod 348 is connected to four crossbars 350 forming an H-shaped configuration. Each crossbar 350 extends transversely across the corresponding connecting rod 348 and is configured to transmit reciprocating motion from the connecting rod 348 to the at least one air pump 410 disposed adjacent to the hexagonal steel plate 332. When provided in a plural number, the crossbars 350 are horizontally spaced apart along the connecting rod 348 to distribute the pumping action across the at least one air pump 410. The H-shaped configuration of the crossbars 350 provides balanced transmission of forces from the connecting rod 348 to the at least one air pump 410, reducing localized stress concentrations and improving mechanical stability during high-speed operation.

As illustrated in FIG. 4, the H-shaped configuration is formed by four crossbars 350 attached to a single connecting rod 348, with two crossbars 350 extending from the connecting rod 348 in one lateral direction and two crossbars 350 extending in the opposite lateral direction, creating an H-shape when viewed from the side. Each of the four crossbars 350 terminates at an air pump actuator interface. The crossbars 350 are horizontally spaced apart along the length of the connecting rod 348 (for example, with 10 cm spacing between adjacent crossbars 350), allowing each connecting rod 348 to actuate four air pumps 410 simultaneously. The H-configuration provides mechanical advantage: when the connecting rod 348 reciprocates, all four crossbars 350 move in unison, distributing the applied force across four air pumps 410 rather than concentrating it on a single air pump 410, thereby reducing wear on respective air pumps 410 and enabling each air pump 410 to operate at a lower force level while collectively achieving the desired total compressed air output.

As shown in FIG. 4, ends of the crossbars 350 are mechanically coupled to the air pumps 410 such that reciprocating motion of the connecting rod 348 is distributed to the air pumps 410 arranged around the hexagonal steel plate 332.

In one specific embodiment, the fan system 300 comprises six medium gears 340, six small gears 344, six connecting rods 348, and twenty-four crossbars 350. This configuration provides balanced force distribution around the hexagonal steel plate 332 and enables simultaneous operation of twenty-four air pumps 410. The hexagonal arrangement of the connecting rods 348 and crossbars 350 enables substantially uniform distribution of mechanical forces and air pump actuation around the perimeter of the gear assembly 330.

### Gear Assembly Operation

When wind force acts on the plurality of blades 312, the fan 310 begins to rotate. The rotational motion is transferred through the central shaft 320 to the largest gear 336. The largest gear 336 drives the at least one medium gear 340 to rotate. The rotational speed relationship between the largest gear 336 and the at least one medium gear 340 is determined by a gear ratio; the gear ratio is defined by relative diameters or tooth counts of the gears and configured to increase the rotational speed. The at least one medium gear 340 then drives the at least one small gear 344 to rotate at an even higher speed. The even higher speed is determined by a gear ratio relative to the at least one medium gear 340 and is even higher due to the further gear ratio increase.

As each small gear 344 rotates, it drives the connecting rod 348 connected to its inner ring 346. The connecting rod 348 moves in a reciprocating linear motion perpendicular to the hexagonal steel plate 332. This reciprocating motion is synchronized with the rotation of the small gear 344. In one embodiment, the connecting rod 348 is coupled to the inner ring 346 of the small gear 344 through an eccentric mounting arrangement such that rotational motion of the small gear 344 is converted into linear reciprocating motion of the connecting rod 348. The amplitude and frequency of the reciprocating motion are determined by the eccentric offset and rotational speed of the small gear 344, thereby enabling controlled actuation of the air pumps 410.

As shown in FIG. 2, the eccentric mounting arrangement comprises an eccentric pin or offset boss extending from one face of the small gear 344 at a location radially offset from the center of rotation of the small gear 344. The upper end of the connecting rod 348 is pivotally coupled to this eccentric pin. As the small gear 344 rotates about its central axis 720, the eccentric pin traces a circular path, causing the connecting rod 348 to move back and forth in a linear reciprocating motion. The eccentric offset distance (the radial distance from the gear center to the pin center) determines the stroke length of the connecting rod 348, which in turn determines the compression stroke of the air pumps 410. Typical eccentric offset values range from 2 cm to 10 cm depending on the desired air pump displacement volume.

The crossbars 350 connected to each connecting rod 348 transmit this reciprocating motion to the air pumps 410 in the compressed gas system 400, thereby converting wind force into compressed air. In the drawings, rotational motion of the gears may be indicated by curved arrows and reciprocating motion of the connecting rods 348 may be indicated by linear arrows to illustrate operational movement of the components.

### Equal-Angle Rotational Segment Distribution

In accordance with an important aspect of the invention, the complete rotational cycle of the gear assembly 330 (360 degrees) is divided into at least two equal-angle rotational segments. Each equal-angle rotational segment corresponds to at least one air pump 410. The equal-angle rotational segments can be 90-degree segments, 60-degree segments, or 45-degree segments, depending on the desired pumping configuration. In specific embodiments, the equal-angle rotational segments are defined as 90-degree segments, 60-degree segments, or 45-degree segments corresponding to four, six, or eight pumping phases within a complete rotational cycle.

The selection among 90-degree, 60-degree, or 45-degree segments depends on the number of air pumps 410 and desired pumping smoothness. For configurations with four air pumps 410 per connecting rod, 90-degree segments provide optimal distribution (360°/4=90°). For configurations with six air pumps 410 per connecting rod, 60-degree segments are selected (360°/6=60°). For configurations with eight air pumps 410 per connecting rod, 45-degree segments are selected (360°/8=45°). Smaller angle segments result in more frequent pumping actions per rotation, producing smoother compressed air generation with reduced pulsation, at the cost of increased mechanical complexity.

Two operational methods are disclosed for the equal-angle rotational segment distribution:

### Method 1: Sequential Drive

The air pumps 410 sequentially complete the pumping action according to the rotational sequence of the equal-angle rotational segments. At any given time point, only the air pump corresponding to one equal-angle rotational segment is in the pumping action, while the remaining air pumps 410 are in the non-pumping action. For example, with four equal-angle rotational segments of 90 degrees each, the air pumps 410 complete their compression strokes in sequence as the gear assembly 330 rotates through the first segment (0°to 90°), the second segment (90°to 180°), the third segment (180°to 270°), and the fourth segment (270°to 360°).

### Method 2: Diagonal Synchronous Drive

The air pumps 410 corresponding to two equal-angle rotational segments separated by 180 degrees simultaneously perform the pumping action. After completion, the air pumps 410 corresponding to another two equal-angle rotational segments separated by 180 degrees simultaneously perform the pumping action. This maintains symmetric force on both sides of the gear assembly 330 during rotation, reducing mechanical stress and vibration.

### Compressed Gas System Structure

Referring to FIGS. 1, 3, and 4, the compressed gas system 400 comprises at least one air pump 410, at least one inlet 420, at least one air cylinder 440, and at least one outlet 460. The air pumps 410 are disposed around the outer edge of the gear assembly 330, positioned to receive reciprocating motion from the crossbars 350.

Each air pump 410 is mechanically connected to the gear assembly 330 through a corresponding one of the crossbars 350. When the crossbar 350 moves toward the air pump 410, the crossbar 350 actuates the air pump 410 to compress air inside an air pump chamber 412. When the crossbar 350 moves away, the air pump 410 draws in ambient air for the next compression cycle. The compressed air generated by each air pump 410 is transmitted through at least one inlet 420 to at least one air cylinder 440. Each air pump 410 may further comprise an intake valve 414 and an exhaust valve 416 configured to allow one-way airflow during the compression cycle, thereby preventing backflow and improving compression efficiency.

In a preferred embodiment with one fan system 300, twenty-four air pumps 410 are disposed around a hexagonal configuration 700 formed by the connecting rods 348. Four air pumps 410 are positioned on each of the six sides of the hexagonal configuration 700. This arrangement provides balanced force distribution and efficient space utilization.

In a larger-scale embodiment comprising eight fan systems 300, one hundred ninety-two air pumps 410 (twenty-four per fan system) are mechanically connected to the eight fan systems 300. This configuration is suitable for power station applications requiring high compressed air generation capacity.

The at least one inlet 420 serves as a conduit fluidly connecting the air pumps 410 to the air cylinders 440. The inlet 420 may be configured as individual tubes from each air pump 410 or as an inlet manifold 430 collecting compressed air from the air pumps 410. In single fan system embodiments, the inlet 420 may comprise individual conduits from each air pump 410 or a simple collection header. In multi-fan system embodiments, compressed air received through the at least one inlet 420 may be routed to the at least one inlet manifold 430. Each inlet manifold 430 may receive compressed air from a corresponding inlet 420 or from a plurality of inlets 420 associated with multiple fan systems 300. The inlet manifold 430 may comprise a branched collection structure having a common trunk line configured to distribute compressed air to the plurality of air cylinders 440. The inlet manifold 430 provides superior pressure equalization compared to configurations using individual inlets 420, ensuring that compressed air from the fan systems 300 experiencing higher wind speeds does not create back-pressure that would impede the air pumps 410 on the fan systems 300 experiencing lower wind speeds.

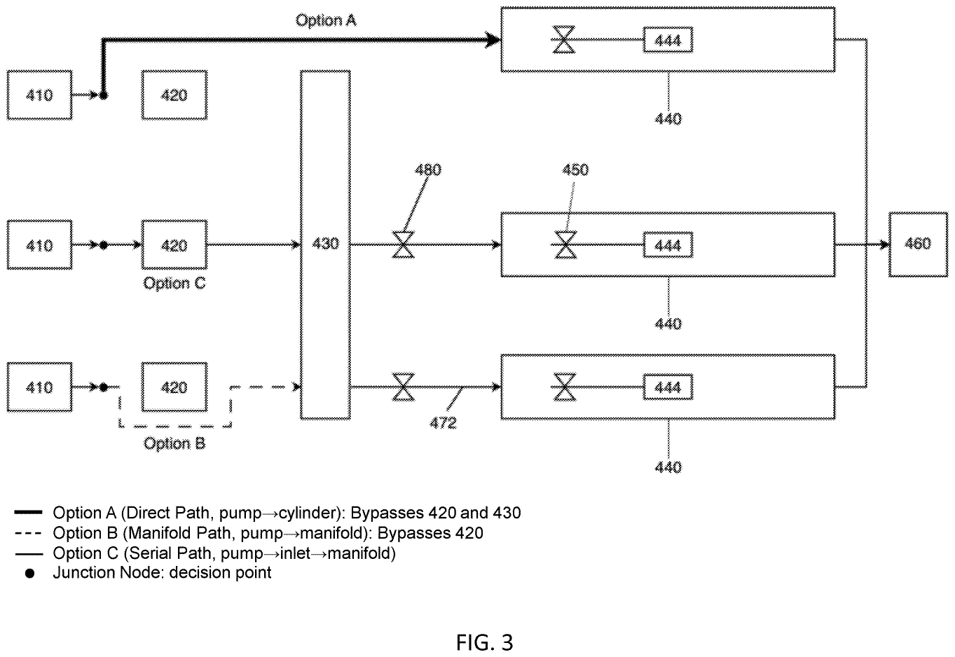

As shown in FIG. 3, the at least one inlet 420 and the inlet manifold 430 are selectively utilized to collect compressed air from the air pumps 410 and distributes the compressed air to the plurality of air cylinders 440.

The at least one air cylinder 440 serves two primary functions: (1) balancing wind speed variations by storing compressed air during periods of strong wind and releasing it during periods of weak wind, and (2) providing adjustable storage capacity based on power generation requirements.

In preferred embodiments, the number of air cylinders 440 is selected based on the desired output stability requirement. A small-scale configuration uses two air cylinders 440, suitable for residential rooftop installations. A medium-scale configuration uses five to six air cylinders 440, suitable for community or small commercial applications. A large-scale configuration uses ten air cylinders 440, suitable for power station applications. An increase in the number of air cylinders 440 increases buffering capacity to reduce pressure fluctuations in the compressed gas system 400.

In a specific embodiment, each air cylinder 440 is an oxygen cylinder adapted for storing compressed air. Each air cylinder 440 further comprises a pressure gauge 442, a variable-volume chamber 444 fluidly connected to the at least one inlet 420 and the at least one outlet 460, and at least one pressure-regulating valve 450 disposed between the at least one inlet 420 and the variable-volume chamber 444.

The pressure gauge 442 provides real-time monitoring of the internal pressure within the air cylinder 440. The variable-volume chamber 444 is the main storage compartment within the air cylinder 440 that accommodates compressed air. The variable-volume chamber 444 is termed “variable-volume” because its effective storage capacity can be adjusted based on the pressure and quantity of compressed air being stored. In certain embodiments, the variable-volume chamber 444 may incorporate a movable piston 514 or expandable membrane that allows the chamber volume to increase as compressed air enters and decrease as compressed air is released. This variable-volume characteristic enables the variable-volume chamber 444 to accommodate fluctuating compressed air input rates while maintaining controlled output pressure. The ability of the variable-volume chamber 444 to expand and contract smoothly reduces pressure spikes that would otherwise occur with fixed-volume storage, thereby improving the stability of compressed air delivery to a steam engine.

The pressure-regulating valve 450 is configured to control inflow of compressed air into the variable-volume chamber 444 based on pressure within the at least one air cylinder 440. When the internal pressure reaches a predetermined threshold, the pressure-regulating valve 450 restricts or stops additional compressed air inflow, preventing over-pressurization. In certain embodiments, a safety relief valve 452 is additionally provided on each air cylinder 440 to automatically release compressed air when the internal pressure exceeds a predetermined safety threshold. When the internal pressure drops below a threshold, the valve opens to allow more compressed air to enter. This control mechanism ensures that fluctuations in compressed air input caused by varying wind force are dampened prior to release through the at least one outlet 460, thereby stabilizing the compressed air supply to the power system 500.

The at least one outlet 460 is fluidly connected to the air cylinders 440 and provides a controlled release path for compressed air to flow to the power system 500. The outlet 460 may include valves or flow control devices 462 to regulate the release rate of compressed air. In FIG. 3, pressure-regulating valves 450 are disposed along flow paths 472 between the inlet manifold 430 and the air cylinders 440 and between the air cylinders 440 and the outlet 460 to control airflow and maintain desired pressure levels within the compressed gas system 400.

### Power System Structure

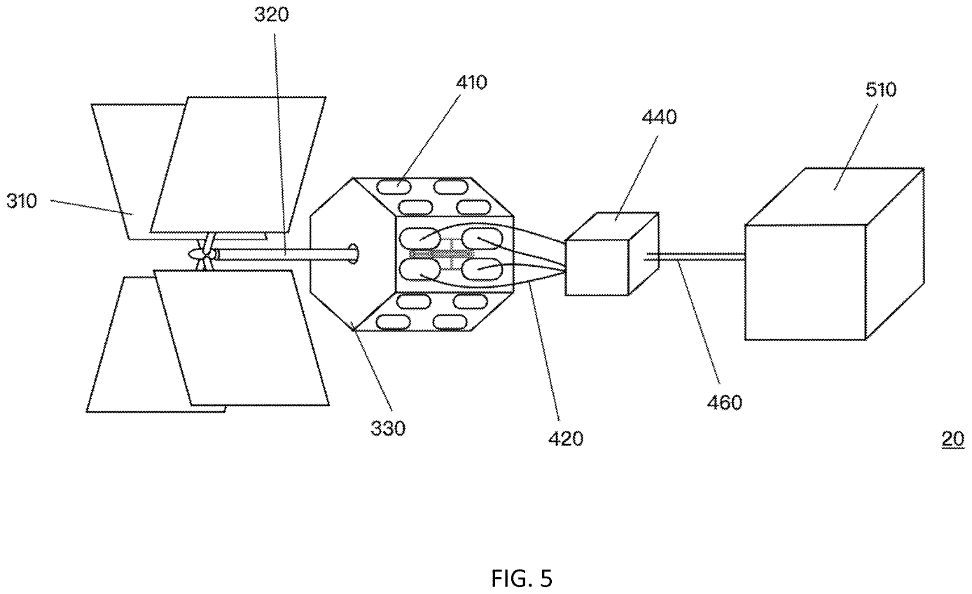

Referring to FIGS. 1 and 5, the power system 500 comprises a steam engine 510 fluidly connected to the at least one outlet 460 of the compressed gas system 400 and configured to be driven by the compressed air. However, unlike conventional steam engines that operate using steam generated by burning fuel, the steam engine 510 in the disclosure is configured to be driven solely by compressed air supplied from the compressed gas system 400 without combustion.

The steam engine 510 receives compressed air from the compressed gas system 400 through the at least one outlet 460. The compressed air enters the cylinder chamber 512 of the steam engine 510, where the compressed air expands and drives a piston 514. The reciprocating motion of the piston 514 is converted to rotational motion through a crankshaft mechanism 516. The rotational motion drives an electrical generator (not shown) to produce electrical power.

By using compressed air instead of steam, the power system 500 eliminates the need for fuel combustion, water heating, and steam generation equipment. This significantly reduces system complexity, eliminates carbon emissions, and lowers operating costs.

### System-Level Configuration

In accordance with another aspect of the invention, a wind power generation system 10 comprises a plurality of fan systems 300 sharing a compressed gas system 400. This system-level configuration provides enhanced stability and continuous power output.

The plurality of fan systems 300 are disposed in an array, with each fan system 300 comprising a fan 310, a central shaft 320, and a gear assembly 330 configured to drive at least one air pump 410. The plurality of fan systems 300 are configured to rotate in response to wind force from a larger area, increasing total energy harvesting capacity. The plurality of fan systems 300 may be configured such that failure or reduced performance of one fan system 300 does not interrupt overall system operation, thereby providing redundancy and improving system reliability.

System redundancy is achieved through the shared compressed gas system architecture. Because all the fan systems 300 feed into the common inlet manifold 430 and all the air cylinders 440 are supplied from the inlet manifold 430, the loss of one fan system 300 merely reduces the total compressed air generation rate by the fractional contribution of that fan system 300 (for example, by 12.5% in an eight-fan-system configuration). The remaining functional fan systems 300 continue to supply compressed air to all the air cylinders 440, and the buffering capacity of the air cylinders 440 compensates for the reduced input rate by drawing upon stored compressed air until the failed fan system 300 can be repaired or wind conditions improve. This contrasts with conventional wind turbine systems where failure of a single turbine-generator unit results in complete loss of that unit's power contribution with no compensation mechanism.

The compressed gas system 400 is shared among the plurality of fan systems 300. The compressed gas system 400 comprises the plurality of air pumps 410 respectively driven by the plurality of fan systems 300, at least one inlet manifold 430 fluidly connected to the plurality of air pumps 410, a plurality of air cylinders 440 fluidly connected to the inlet manifold 430, and at least one outlet 460 fluidly connected to the plurality of air cylinders 440.

The inlet manifold 430 serves as a central collection point for compressed air from all the air pumps 410 across all the fan systems 300. By consolidating the compressed air flows, the inlet manifold 430 enables efficient distribution to the plurality of air cylinders 440.

The compressed gas system 400 further comprises at least one flow control mechanism 470 comprising at least one pressure-regulating valve 450. The flow control mechanism 470 is configured to: (1) regulate compressed air input from the plurality of air pumps 410 into the plurality of air cylinders 440 based on pressure conditions within the compressed gas system 400, and (2) selectively distribute compressed air from the plurality of air cylinders 440 to the steam engine 510 to provide a compressed air output having reduced pressure fluctuations and being independent of instantaneous wind force variations across the plurality of fan systems 300. The selective distribution of compressed air may be achieved by controlling opening and closing states of the at least one pressure-regulating valve 450 based on pressure differentials, thereby directing compressed air flow to the steam engine 510 in a controlled and continuous manner.

In a specific embodiment, the compressed gas system 400 further comprises a plurality of flow paths 472 extending between and fluidly connecting the inlet manifold 430 and the plurality of air cylinders 440, and a plurality of pressure-regulating elements 480 respectively disposed along the flow paths 472. Each pressure-regulating element 480 is configured to control airflow into a corresponding one of the plurality of air cylinders 440 based on pressure within that the air cylinder 440. This ensures that compressed air received from different fan systems 300 is distributed among the plurality of air cylinders 440 to reduce pressure differentials prior to delivery to the steam engine 510. The flow paths 472 may comprise conduits, piping networks, or manifold branches 432 extending between the inlet manifold 430 and the plurality of air cylinders 440 and dimensioned to balance flow resistance and ensure substantially uniform distribution of compressed air among the plurality of air cylinders 440.

Proper dimensioning of the flow paths 472 is important for achieving uniform distribution. In a preferred embodiment, each flow path 472 from the inlet manifold 430 to a corresponding one of the air cylinders 440 has substantially the same length and internal diameter to provide equal flow resistance. For example, in a system with ten air cylinders 440, ten flow paths 472 of equal length (such as 3 meters each) and equal diameter (such as 2-inch inner diameter) may be used, with each flow path 472 branching from the inlet manifold 430 at evenly-spaced locations. This geometric symmetry ensures that compressed air encounters the same pressure drop regardless of which cylinder it flows toward, preventing preferential filling of certain cylinders over others and maintaining balanced pressure levels across the entire air cylinder array.

The pressure-regulating elements 480 comprise at least one valve selected from the group consisting of a check valve 482, a relief valve 484, and a pressure-actuated control valve 486. The check valve 482 prevents backflow of compressed air from the air cylinders 440 to the inlet manifold 430. The relief valve 484 releases excess pressure if any one of the air cylinders 440 becomes over-pressurized. The pressure-actuated control valve 486 automatically adjusts its opening based on the pressure differential across the valve, providing self-regulating flow control. Each type of pressure-regulating element 480 serves a specific function in the system. The check valve 482 is a one-way valve that permits compressed air to flow from the inlet manifold 430 into the air cylinders 440 but prevents reverse flow from the cylinder back to the inlet manifold 430, thereby maintaining pressure in the cylinders even when air pump operation temporarily ceases due to calm wind conditions. The relief valve 484 is a safety device that automatically opens when pressure in any one of the air cylinders 440 exceeds a predetermined maximum threshold (such as 150 psi or 200 psi depending on cylinder design), venting excess compressed air to atmosphere to prevent over-pressurization and potential cylinder rupture. The pressure-actuated control valve 486 is a proportional valve that modulates its flow area based on the pressure differential between the inlet manifold 430 and a specific one of the air cylinders 440; when the cylinder pressure is low, the valve opens wider to allow rapid filling, and when the cylinder pressure approaches the manifold pressure, the valve restricts flow to prevent pressure overshoot, thereby achieving balanced pressure distribution across all the air cylinders 440 without requiring external control electronics.

In a preferred system embodiment, the plurality of fan systems 300 comprises eight fan systems 300 and the air pumps 410 comprises one hundred ninety-two air pumps 410. The air pumps 410 are distributed among the fan systems 300 (twenty-four per fan system) to provide balanced compressed air input to the inlet manifold 430.

In another aspect, each fan 310 of the plurality of fan systems 300 comprises blades 312 with jet nozzles 316 disposed on windward surfaces 314 thereof to direct airflow along the windward surfaces 314. This feature reduces rotational variation among the plurality of fan systems 300 by accelerating fan rotation even during periods of moderate wind, thereby improving consistency of compressed air generation across the system.

In yet another aspect, each gear assembly 330 operates according to an equal-angle rotational segment distribution method (as described previously). Furthermore, the plurality of fan systems 300 are phase-offset relative to each other such that compressed air generation from the plurality of air pumps 410 is temporally distributed across a rotational cycle. For example, if the system includes eight fan systems 300, their gear assemblies can be offset by 45-degree increments (360°/8=45°). This phase offset ensures that at any given moment, different fan systems 300 are at different points in their pumping cycles, resulting in more continuous and stable compressed air generation at the system level.

In a preferred system embodiment, the phase offset between the plurality of fan systems 300 may be predetermined based on a number of the fan systems 300 and desired output smoothness, such that rotational cycles of the gear assemblies are intentionally staggered to minimize simultaneous peak or trough output conditions.

In another preferred system embodiment, the phase-offset configuration can be implemented mechanically by installing the fan systems 300 with their central shafts 320 and largest gears 336 at different angular positions relative to a common reference orientation, or operationally by starting the fan systems 300 at staggered times to establish the desired phase relationships. Once established, the phase offset is maintained by the mechanical coupling of each fan 310 to its gear assembly 330. The practical benefit of phase offsetting is significant: instead of all eight fan systems 300 simultaneously reaching peak compression (which would create a large pressure spike) and simultaneously reaching minimum compression (which would create a pressure valley), the system experiences eight smaller, evenly-distributed compression peaks throughout each rotation cycle, resulting in substantially smoother aggregate compressed air flow to the inlet manifold 430.

### Operational Flow

The complete operational flow of the wind power generation system 10 is as follows:
(1) Wind force acts on the blades 312, causing the fan 310 to rotate.
(2) The rotation of the fan 310 drives the central shaft 320 and the largest gear 336 to rotate.
(3) The largest gear 336 drives the medium gears 340, which in turn drive the small gears 344 at increased rotational speeds.
(4) The small gears 344 drive the connecting rods 348 in reciprocating motion.
(5) The connecting rods 348 drive the crossbars 350, which actuate the air pumps 410.
(6) The air pumps 410 perform a pumping action that compresses ambient air to generate compressed air and deliver the compressed air to the inlet 420 or the inlet manifold 430.
(7) Compressed air flows through the inlet 420 or, in an alternative configuration, through the inlet manifold 430 into the air cylinders 440.
(8) The air cylinders 440 store the compressed air and balance pressure fluctuations caused by wind speed variations.
(9) Compressed air is released from the air cylinders 440 through the outlet(s) 460 in a controlled manner.
(10) The compressed air enters the steam engine 510 and drives the piston mechanism or crankshaft mechanism 516.
(11) The rotational output of the steam engine 510 drives an electrical generator to produce power.
(12) Continuous power generation is achieved as the air cylinders 440 maintain stable compressed air supply regardless of instantaneous wind conditions.

### Advantages Over Conventional Technology

The wind power generation device 20 and system 10 of the disclosure provide significant improvements over conventional wind power technology:

Compared to direct-drive wind turbines: The disclosure decouples wind capture (i.e., fan rotating in response to wind force) from power generation through compressed air storage, eliminating intermittency problems. Conventional direct-drive systems cannot provide power when wind stops; the system of the disclosure continues generating power using stored compressed air.

Compared to battery storage systems: The disclosure uses compressed air storage, which has no degradation over time, unlimited charge-discharge cycles, and no toxic materials. Conventional battery systems degrade after several years and require expensive replacement.

Compared to conventional pneumatic systems: According to the disclosure, the unique gear assembly 330 configuration with equal-angle rotational segment distribution optimizes air pump efficiency and balances mechanical forces. The hexagonal configuration 700 provides compact space utilization compared to conventional linear air pump arrangements.

Environmental impact: By eliminating combustion and using only wind force and compressed air, the system of the disclosure produces zero carbon emissions during operation. The system of the disclosure reduces reliance on conventional fossil fuel power plants while providing the stable, continuous output that conventional wind turbines cannot achieve without fossil fuel backup.

Scalability and adaptability: The modular design allows the system of the disclosure to be scaled from small residential installations (one fan system 300, two air cylinders 440) to large power station configurations (eight fan systems 300, ten air cylinders 440) using the same fundamental technology.

The disclosure is tolerant of manufacturing variations, material differences, and assembly tolerances. Precise dimensions or exact angles are not required. Directional terms such as “windward,” “outward,” and “toward” are used for descriptive convenience only and do not limit the disclosure. The scope of the disclosure is defined solely by the appended claims and their equivalents.

Many alterations and modifications may be made by those having ordinary skill in the art without departing from the spirit and scope of the disclosed embodiments. Therefore, it must be understood that the illustrated embodiments have been set forth only for the purposes of example and that they should not be taken as limiting the embodiments as defined by the following claims.

Thus, specific embodiments and applications of the wind power generation device and system of the disclosure have been disclosed. It should be apparent, however, to those skilled in the art that many more modifications besides those already described are possible without departing from the disclosed concepts herein. Therefore, the disclosed embodiments are not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

The words used in this specification to describe the various embodiments are to be understood not only in the sense of their commonly defined meanings but also to include, by special definition in this specification, structure, material, or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in the same way to obtain the same result.

What is claimed is:

1. A wind power generation device, comprising:
at least one fan system comprising a fan, a central shaft, and a gear assembly, wherein gear assembly comprises a hexagonal steel plate, a largest gear, at least one medium gear, at least one small gear, at least one connecting rod, and at least one crossbar, the fan being connected to the central shaft, the largest gear meshing with the at least one medium gear, the at least one medium gear each being supported by a ball bearing shaft and meshing with the at least one small gear, the at least one small gear having an inner ring connected to one end of the at least one connecting rod, the at least one crossbar being fixed on a side edge of the hexagonal steel plate and having one end meshing with the at least one connecting rod, wherein the largest gear, the at least one medium gear, the at least one small gear being mounted on the hexagonal steel plate, and the at least one connecting rod being operatively connected to the at least one small gear and disposed around the gear assembly, wherein the fan is configured to rotate in response to wind force, the rotation of the fan drives the central shaft and the largest gear to rotate, the largest gear drives the at least one medium gear and the at least one small gear to rotate, and the at least one small gear drives the at least one connecting rod to convert the wind force into compressed air;
a compressed gas system comprising at least one air pump, at least one inlet, at least one air cylinder, and at least one outlet, wherein the at least one air pump is mechanically connected to the gear assembly and fluidly connected to the at least one inlet, the at least one inlet is fluidly connected to the at least one air cylinder, the at least one air cylinder is fluidly connected to the at least one outlet, the at least one small gear drives the at least one connecting rod to actuate the at least one air pump to perform a pumping action that compresses air to generate compressed air delivered through the at least one inlet to the at least one air cylinder and discharged through the at least one outlet; and
a power system comprising a steam engine fluidly connected to the at least one outlet and configured to be driven by the compressed air.

2. The device of claim 1, wherein the at least one fan system comprises six medium gears, six small gears, six connecting rods, and twenty-four crossbars, and the compressed gas system comprises twenty-four air pumps.

3. The device of claim 1, wherein each blade of the fan has a jet nozzle disposed on a windward surface thereof and configured to direct airflow along the windward surface to accelerate a rotational speed of the fan.

4. The device of claim 1, wherein the at least one small gear is disposed on one side of the hexagonal steel plate, and the inner ring of the small gear is connected to one end of the connecting rod, the connecting rod encircling a side edge of each small gear to form an outer edge of the gear assembly, each connecting rod being connected to four crossbars forming an H-shaped configuration, the crossbars being horizontally spaced apart and connected to the connecting rod, the small gear driving the connecting rod to drive the crossbar toward four air pumps of the compressed gas system to perform the pumping action.

5. The device of claim 1, comprising eight fan systems, wherein the compressed gas system comprises one hundred ninety-two air pumps connected to the eight fan systems.

6. The device of claim 1, wherein the at least one air cylinder further comprises: a pressure gauge; a variable-volume chamber fluidly connected to the at least one inlet and the at least one outlet; and at least one pressure-regulating valve disposed between the at least one inlet and the variable-volume chamber, wherein the pressure-regulating valve is configured to control inflow of compressed air into the variable-volume chamber based on pressure within the at least one air cylinder, such that fluctuations in compressed air input caused by varying wind force are dampened prior to release through the at least one outlet.

7. The device of claim 1, wherein a complete rotational cycle of the gear assembly is divided into at least two equal-angle rotational segments, each equal-angle rotational segment corresponding to the at least one air pump and being selected from 90-degree, 60-degree, or 45-degree segments.

8. The device of claim 7, wherein the air pumps sequentially complete the pumping action according to a rotational sequence of the equal-angle rotational segments, such that at any given time point only the air pump corresponding to one equal-angle rotational segment is in the pumping action while remaining air pumps are in the non-pumping action.

9. The device of claim 7, wherein the air pumps corresponding to two equal-angle rotational segments separated by 180 degrees simultaneously perform the pumping action, and after completion, the air pumps corresponding to another two equal-angle rotational segments separated by 180 degrees simultaneously perform the pumping action to maintain symmetric force on both sides of the gear assembly during rotation.

10. The device of claim 1, wherein the steam engine is configured to be driven solely by compressed air supplied from the compressed gas system without combustion.

11. A wind power generation system, comprising:
a plurality of fan systems, each fan system comprising a fan, a central shaft, and a gear assembly configured to drive at least one air pump;
a compressed gas system shared among the plurality of fan systems, the compressed gas system comprising:
a plurality of air pumps respectively driven by the plurality of fan systems,
at least one inlet manifold fluidly connected to the plurality of air pumps,
a plurality of air cylinders fluidly connected to the inlet manifold, and
at least one outlet fluidly connected to the plurality of air cylinders; and
a power system comprising a steam engine fluidly connected to the at least one outlet;
wherein the compressed gas system further comprises at least one flow control mechanism comprising at least one pressure-regulating valve configured to:
regulate compressed air input from the plurality of air pumps into the plurality of air cylinders based on pressure conditions within the compressed gas system, and
selectively distribute compressed air from the plurality of air cylinders to the steam engine to provide a compressed air output having reduced pressure fluctuations and being independent of instantaneous wind force variations across the plurality of fan systems.

12. The system of claim 11, wherein the plurality of fan systems comprises eight fan systems and the plurality of air pumps comprises one hundred ninety-two air pumps, the air pumps being distributed among the fan systems to provide balanced compressed air input to the inlet manifold.

13. The system of claim 11, wherein the plurality of air cylinders is selected based on a desired output stability requirement, including:
two air cylinders for a small-scale configuration,
five to six air cylinders for a medium-scale configuration, and
ten air cylinders for a large-scale configuration,
wherein an increase in the number of air cylinders increases buffering capacity to reduce pressure fluctuations in the compressed gas system.

14. The system of claim 11, wherein each fan of the plurality of fan systems has blades with jet nozzles disposed on windward surfaces thereof to direct airflow along the windward surfaces to reduce rotational variation among the plurality of fan systems.

15. The system of claim 11, wherein each gear assembly operates according to an equal-angle rotational segment distribution method, and the plurality of fan systems are phase-offset relative to each other such that compressed air generation from the plurality of air pumps is temporally distributed across a rotational cycle.

16. The system of claim 11, further comprising:
a plurality of flow paths connecting the inlet manifold to the plurality of air cylinders; and
a plurality of pressure-regulating elements respectively disposed along the flow paths,
wherein each pressure-regulating element is configured to control airflow into a corresponding air cylinder based on pressure within that air cylinder, such that compressed air received from different fan systems is distributed among the plurality of air cylinders to reduce pressure differentials prior to delivery to the steam engine,
wherein the pressure-regulating elements comprise at least one valve selected from the group consisting of a check valve, a relief valve, and a pressure-actuated control valve.
